(19) United States
(12) Patent Application Publication
(10) Pub. No.: US 2013/0146731 A1
(43) Pub. Date: Jun. 13, 2013

(54) Drywall Construction Material Mounting Tool

(71) Applicant: Henry Powell, III, Kensington, MD (US)

(72) Inventor: Henry Powell, III, Kensington, MD (US)

(21) Appl. No.: 13/246,858

(22) Filed: Dec. 12, 2011

(51) Int. Cl. F16M 13/02

(52) U.S. Cl. 248/324

(57) ABSTRACT

The invention describes a mounting system which is used for lifting, shifting, altering, and final placement of construction material, such as dry wall, sheetrock, Durock, wood paneling, and ceiling panels, to overhead to ceiling joists and\or stud wall(s) by a single individual without any assistance. The device is portable, light-weight, and has multiple use when attaching construction material to ceiling joist and\or wall studs. The mounting system consists of two (2) swing arm support braces and two (2) support braces are made of, high-density polyethylene (further known as HDPE cross) and a swing arm assembly which consists light-weight metal and a re-enforced plastic bar.

The invention generally relates to a mounting system—two (2) swing arm support braces and two (2) support braces made of HDPE, and a swing arm assembly, which consists of light-weight metal and a re-enforced plastic crossbar.

The above background and summary outline, rather broadly, some of the features of the invention in order that the detailed description of it may be better understood, and in order that the present contribution to the art may be better appreciated. There are additional features of the invention that will be described hereinafter.

In addition, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a drywall tool which gives one person the ability to lift, support, and alter construction material to an overhead joist and/or wall studs with no assistance.

Another object is to provide a drywall tool that will enable one individual to position and reposition a piece of construction material 4′×8′ or smaller to a ceiling joist and/or wall stud with no assistance.

Another object is to provide a drywall tool that temporarily supports and secures a 4′×8′ panel for hands free final placement and installation.

Another object is to provide a drywall tool that is portable, easy to dismantle, and can be easily transported from one location to another with minimal effort. The invention is versatile, while individual parts can be used for different task thereby minimizing the cost of additional tools.

Another object is to provide a drywall tool that eliminates free-standing mechanical parts.

Another object is to provide a system which allows for multiple use of the components for various tasks that occur while securing construction material to ceiling joists and/or wall studs.

Other objects and advantages of the present invention will become obvious to the reader and it is intended that these advantages are within the scope of the present invention. To the accomplishment of the above and related objects, this invention may be embodied in the form illustrated in the accompanying drawings, attention being called to the fact, however, that the drawings are illustrative only, and that changes maybe made in the specific construction illustrated and described within the scope of this application.

### BACKGROUND OF THE INVENTION

The new invention is a drywall installation mounting system, which assists in the lifting, supporting, positioning, and altering of construction materials by a single individual. The preferred operation supports various construction materials for final securing to ceiling joists and/or wall studs. The invention is a complete system, which includes two swing arm support braces, two support braces, and a swing arm assembly. The invention assists in lifting, supporting, positioning, and securing of various construction material for final placement on both ceiling joist and/or side wall studs performed by a single individual. The patents sited below address either wall and/or ceiling mounting, which may require two people. The cited patents assist in wall mounting but not ceiling joist mounting: U.S. Pat. No. 7,387,293 B2 invented by Lawrence Boucher and issused on Jun. 17, 2008; US Pat. No. 2001/0029715 A1 invented by Stephen Bradley/Brandon Bigler/Mike Jacobsen and issused on Oct. 18, 2001; and U.S. Pat. No. 4,868,943 invented by Allen J Robichaud and issused on Sep. 26, 1989. The cited patents assist in ceiling joist mounting but not wall stud mounting: U.S. Pat. No. 6,467,236 B1 invented by Gary R Schlegel and issused on Oct. 22, 2002; U.S. Pat. No. 5,640,826 invented by Ray Hurilla and issused on Jun. 24, 1997; and U.S. Pat. No. 5,129,774 invented by Lazaro Baiseiro/Henry Lopez and issused on Jul. 14, 1992. The cited patent assist in ceiling mount but swing arm build of 2×4 wood is not light-weight: U.S. Pat. No. 5,163,799 invented by Mitchel W Lynn and issused on Nov. 17, 1992. Normally, it takes two individuals to lift and secure a single sheet of 4×8 panel of construction material (ex. sheetrock) weighing approximately 80 lbs or greater to ceiling joist and/or wall studs. In addtion, while the construction material is being supported by one individual, it requires the other individual to alter the construction material, as needed, for final placement. The patents below does not address a one-man lift and support system: U.S. Pat. No. 5,564,236 invented by David Mckinney/William Pratnicki and issused on Oct. 15, 1996; U.S. Pat. No. 2,180,651 invented by Frederick W Williams and issused on May 4, 1937: U.S. Pat. No. 4,709,527 invented by John Cooley and issused on Dec. 1, 1987; and U.S. Pat. No. 5,249,405 invented by George Miller and issused on Oct. 5, 1993.

The support braces allow an individual to lift and shift a 4×8 panel of construction material for final placement on stud wall. The patents sited below, an individual would need to purchase the items separately, which adds to the cost: U.S. Pat. No. 2,989,286 invented by Boyce Gillespie and issused on Jun. 20, 1961; U.S. Pat. No. 3,871,054 invented by Theodore S Schaefer and issused on May 18, 1975; U.S. Pat. No. 2,692,753 invented by Melvin L Masterson/Cash V Criwell and issused on Mar. 23, 1953; and U.S. Pat. No. 5,814,842 invented by Christopher Muldoon and issused on Sep. 29, 1998.

In addition, the support braces can be used to straighten and reposition bowed 2×4 wood. The patents sited below, an individual would need to purchase the item separately, which adds to the cost: U.S. Pat. No. 386,057 invented by Kenneth W Hrebs and issused on Nov. 11, 1997 and U.S. Pat. No. 2,896,910 invented by Guy R Cooper/Robert Tomlin issused on Jul. 9, 1959.

Install long runs of insulation by securing support arm across joist\studs to eliminate insulation from dislodging during securing process.

The device is portable, light-weight, and has multiple use when attaching construction material to ceiling joist and\or wall studs. There are no parts requiring assembly prior to use and is not a free standing mechanical device. The patents sited below are free-standing devices: U.S. Pat. No. 5,322,403 invented by Robert A Herde and issused on Jun. 21, 1994; U.S. Pat. No. 3,828,942 invented by Roland O. Young and issused on Aug. 13, 1974; and U.S. Pat. No. 7,048,258 B1 invented by Patrick Charles Dromgool issused on May 23, 2006.

### BRIEF DESCRIPTION OF THE DRAWINGS

Various other objects, features and attendant advantages of the present invention will become fully appreciated as the same becomes better understood when considered in conjunction with the accompanying drawings, in which like reference design designate the same or similar parts throughout the several views, and wherein:

FIG. 1: Is a perspective view of a preferred embodiment of the mounting system.

FIG. 2: Illustrates how the mounting system gives hands free flexibility for shifting, altering, and final securing of construction material.

FIG. 3: Is an exploded perspective view of the present invention. It is a 3D view of one of the two (2) swing arm support braces. When both swing arm braces are secured to stud wall a 4×8 panel of construction material can be supported for hand-free shifting, altering, and final securing of panel construction material.

FIG. 4: Is an exploded perspective view of the present invention. It is a 3D view of one of the two (2) support braces. The support brace assists with ceiling joist mounting, wall stud mounting, lifting and shifting a 4×8 panel of construction material, straightening and repositioning bowed 2×4 wood, general support of construction being placed between ceiling joist/wall stub.

FIG. 5: Is an exploded perspective view of the present invention. It is a 3D view of the swing arm assembly consisting of two light-weight metal swing support arms and a re-enforced crossbar.

FIG. 6: Is a side view of the arm support system.

FIG. 7: Illustrates the location of the re-enforced crossbar with relation to swing arm support system.

### DETAILED DESCRIPTION OF THE INVENTION

### A. Overview

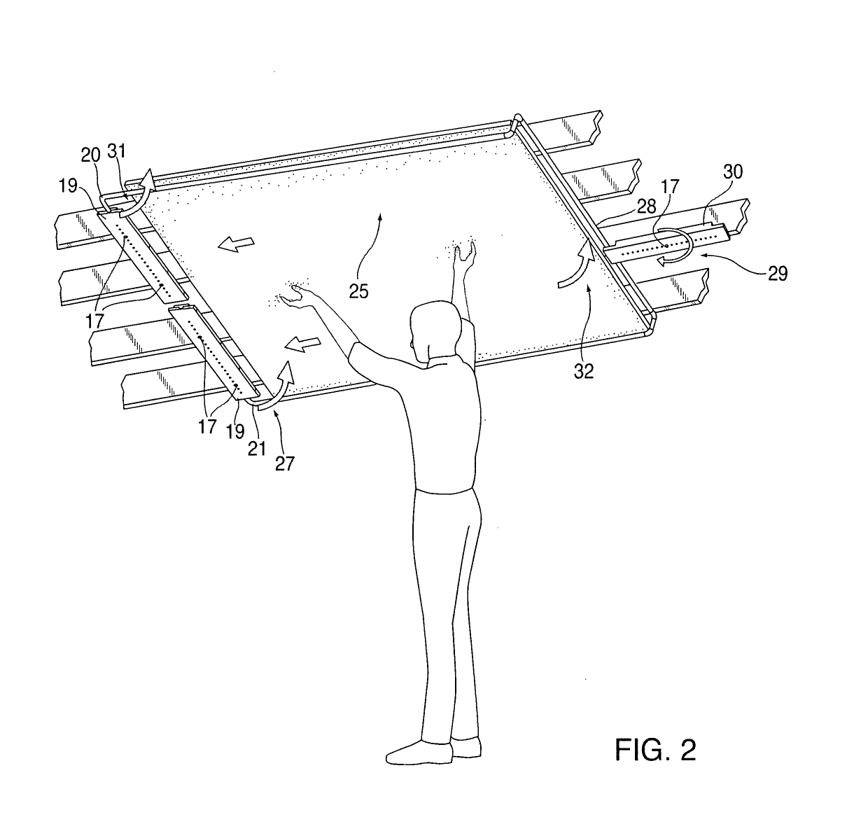

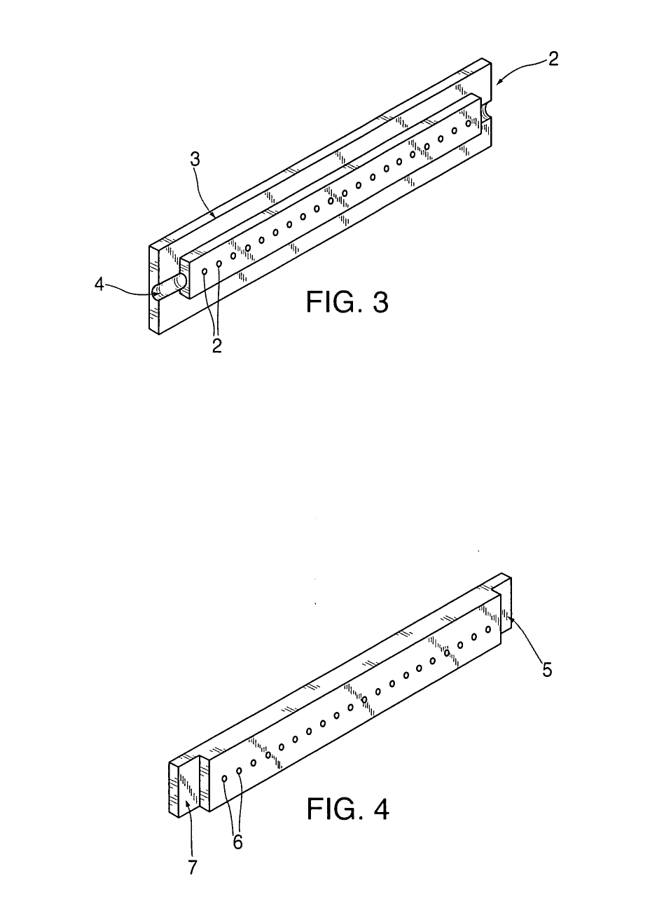

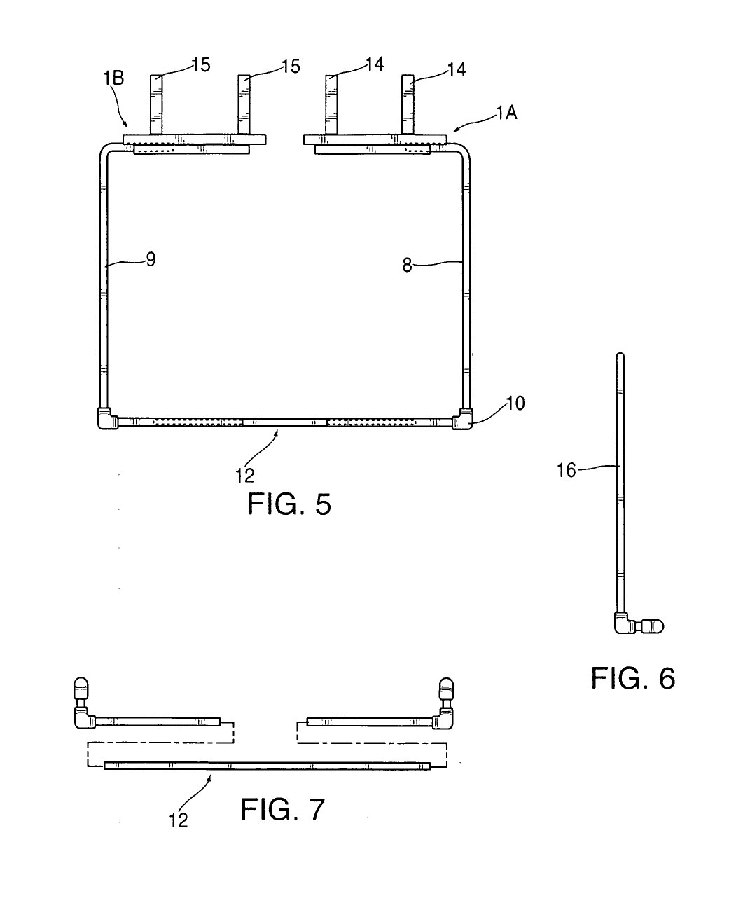

Turning now descriptively to the drawings, in which similar reference characters denote similar elements throughout the several views. The drawings illustrates the mounting system which consist of two (2) swing arm support braces FIG. 3. The swing arm support brace has twenty equally spaced holes, FIG. 3-2, which allows the brace to be secured with typical drywall screws. The lip edge, FIG. 3-3, is used to support the construction material. Both ends of the swing arm brace has circular holes, FIG. 3-2,4, which is the location the swing arm is inserted. Two (2) support braces have twenty equally spaced holes, FIG. 4-6, which allows the brace to be secured with typical drywall screws. The lip edge, FIG. 4-7,5, is used to support the construction material. The swing arm assembly, FIG. 5-7, consists of a left support arm, right support arm, and fiberglass re-enforced crossbar.

### B. Method of Use

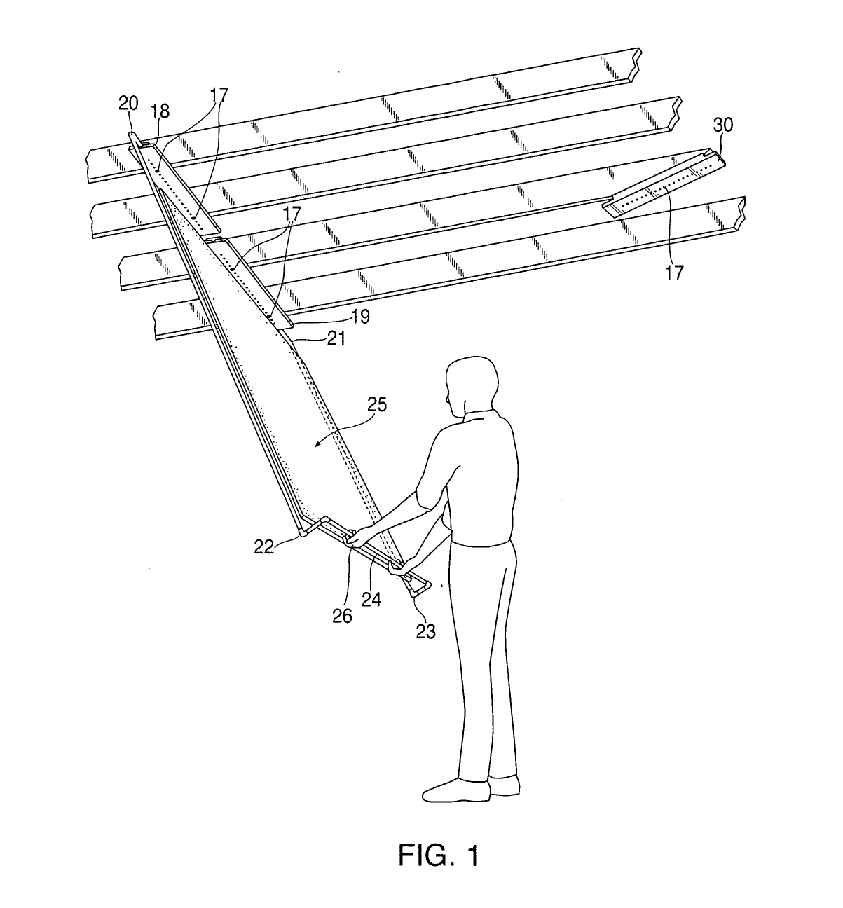

With respect to the drawings illustrated in FIG. 1 the mounting system is used for mounting construction material to ceiling joist. The swing arm support brace is attached perpendicular to ceiling joist with lip edge facing upward to ceiling joist on the right side 18 and left side 19. The support brace should cross two ceiling joist each and be secured with drywall screws and attached washer 17. The user then inserts swing arm 20 and 21 into swing arm support side hole 18 and then swing arm support side hole 19. Lastly, insert re-enforced crossbar 24 into lower arm extension right side 22 and left side 23. Lift swing arm up to ceiling joist to estimate where swing arm will touch ceiling joist and mark the joist. Lower swing arm and then secure with drywall screw 17 support brace 30 so the lip of the support brace is beneath the mark previously made on joist. Turn the support arm away from the mark 30. The swing arm is 50 inches in length and when not being used will be slightly above waist level or at waist level, depending on user height, to maximize lifting strength. The user can then place 4×8 panel of construction material 25 onto swing arm assembly to be lifted, supported, altered, and secured. The construction panel 25 needs to placed on the swing arm with the smooth surface facing the arm 22 and 23 so when raised, the correct side is facing the user. Place the construction panel so the width side rests on the swing arm 22 and 23 Once the user lifts 26 the swing arm with panel of construction material up to ceiling joist, the support brace 30 is turned with the lip underneath the crossbar for support. At this point, the user can perform any necessary adjustments and\or alterations, and then secure.

With respect to the drawings illustrated in FIG. 2 uses the mounting system as support device while the user makes hands-free adjustments. The user has now lifted the panel 27. Once the support brace 30 is turned in a manner that places the lip underneath the re-enforced crossbar 24, the job is hands-free. The user can now lift and shift the edge of construction material 31 forward onto the lip of the swing arm support brace lip for additional support. Next, the user secures construction material with drywall screws starting from support brace 30 towards swing arm support brace 19. Once the construction material is secured to the joist with drywall screws, turn the support brace 30 to lower the swing arm 20 and 21 and remove re-enforced crossbar 24 to remove swing arm 20 and 21 from the swing arm support brace 19. This will minimize clutter in the work area. Now you can finish securing the construction material to the joists. Once final securing of construction panel is complete, remove swing arm support brace 19. Repeat the above mention step for additional construction panels.

With respect to the drawings illustrated in FIG. 4 demonstrates versatile use of support brace. Secure support brace in FIG. 4 (perpendicular) to bowed 2×4 wood with typical drywall screw and washer combination and apply pressure to straighten wood. When necessary, place additional support brace on other side of bowed wood and apply necessary counter-pressure.

To install long runs of insulation, secure support brace in FIG. 4 with one typical drywall screw and washer combination at two different intervals along the same ceiling joist. Place insulation between ceiling joist pivot support brace in FIG. 4 to secure one end while placing remaining roll. Once hung, make final adjustments and secure.

To lift construction material onto wall studs, utilize the two support braces FIG. 4. Place one support brace FIG. 4 on the floor parallel approximately 10 inches from stud wall then place the second support brace FIG. 4 on top of the first support brace FIG. 4 in a perpendicular manor close to the stud wall (like a T). Place the construction material on the lip of the support brace FIG. 4 which creates a see-saw affect lifting the rear. Step on the rear of the support brace FIG. 4 to lift and shift construction material.

Both swing arm support braces FIG. 3 and support brace FIG. 4 can be used when mounting construction material horizontally to wall studs. After placing the bottom row of construction materials, secure swing arm support brace FIG. 3 along the top edge of construction material. Then secure support brace FIG. 4 so the lip edge will hold the side edge of the construction material. Lift construction panel into the lip of FIG. 3. Turn FIG. 4 over the side edge of the construction material to secure it in place. Make any adjustments and secure with drywall screws.

### Operation of Preferred Embodiment

The preferred embodiment of the Dry Wall/Construction Material Tool is to give an individual the ability to secure construction material overhead without assistance. It is portable and can be transported from one job to another with minimal handling, space and strain. There are no free-standing mechanical parts that require servicing. It can be used with numerous construction materials for support and other functions (ie. installing fiberglass, mounting Durock, attaching various kinds of construction material to walls, lifting and shifting various construction materials, etc.) by one individual. It is a simple, portable, and affordable system that can be mass produced for do-it-yourself individuals who wish to eliminate the need for help with positioning, lifting, shifting bracing, adjusting and/or securing construction materials.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, most reasonable sense unless otherwise indicated. Any headings utilized within the description are for convenience only and have no legal or limiting effect.

1. What is new in that the invention consist of a combination of two (2) swing arm support braces and two (2) support braces made of HDPE, and a swing arm assembly, which consists of light-weight metal and a fiberglass re-enforced plastic crossbar. The swing arm support brace is attached perpendicular to ceiling joist with lip edge facing upward to ceiling joist on the right side and left side. The swing arm support brace should cross two ceiling joist each and be secured with drywall screws and attached washer. The user then inserts swing arm into swing arm support side hole for both the right and left swing arm support brace. Then insert the re-enforced crossbar into lower arm extension both right side and left side. At this point the 4×8 construction material is then placed on the swing arm. The user lifts the swing arm, while holding the re-enforced fiberglass cross bar, up to ceiling joist to secure swing arm assembly with lip of the support brace. The support brace is then positioned with the lip underneath the crossbar for support. At this point, the user can perform any necessary adjustments and\or alterations, and then secure the construction material. This process can be done by an individual with no assistance. Minimal weight is added to the total weight to be lifted.

2. The invention can be used for wall stud installation with the combination two (2) swing arm support braces and two (2) support braces made of HDPE. The swing arm support brace is attached perpendicular to wall studs with lip edge facing to wall studs on the right side and left side. The swing arm support brace should cross two wall studs each and be secured with drywall screws and attached washer. The user can then lift the construction material and place in the lip edge. For additional hands free support the user attaches one of the two remaining support braces to the left or right edge of construction material with lip towards wall stud. Then secure support brace with drywall screw and washer. Position lip edge over construction material. At this point, the user can perform any necessary adjustments and\or alterations, and then secure the construction material. This process can be done by an individual with no assistance.

3. When installing long runs of construction material such as installation the user can use braces to assist in holding the installation in place by securing the brace, most preferred is the support brace, and position the brace to run parallel with the joist/wall stud. Install the insulation then position the brace perpendicular to hold the material in place. This process can be done by an individual with no assistance.

4. The support brace has multiple functionalities such as assisting in correcting bowed wood and lifting construction material off the ground surface. Secure the support brace using the hole closest to the lip and perpendicular to the bowed wood. Apply pressure in the opposite direction of the bow. For added support use the other support brace and place behind the bowed wood. Apply pressure on the first support brace attached to the bowed wood until the wood is flat against the second support brace and secure the wood. By crossing the two support braces 90 degrees to create a see-saw affect with the lip of the top support brace positioned upward the user can place the construction material in the lip and then step on the opposite end to lift the construction material upward for final placement and securing.

5. The combination which comprises two (2) swing arm support braces and two (2) support braces made of HDPE, and a swing arm assembly is more portable, has less weight, easier to attach and unattached from panel to panel, and with multiple functionality.
